(19) United States
(12) Patent Application Publication
(10) Pub. No.: US 2022/0414990 A1
(43) Pub. Date: Dec. 29, 2022

(54) AUGMENTED REALITY SYSTEM AND OPERATION METHOD THEREOF

(71) Applicant: Acer Incorporated, New Taipei City (TW)

(72) Inventors: Chih-Wen Huang, New Taipei City (TW); Wen-Cheng Hsu, New Taipei City (TW); Yu Fu, New Taipei City (TW); Chao-Kuang Yang, New Taipei City (TW)

(73) Assignee: Acer Incorporated, New Taipei City (TW)

(21) Appl. No.: 17/723,497

(22) Filed: Apr. 19, 2022

(30) Foreign Application Priority Data
Jun. 25, 2021 (TW) 110123328

(51) Int. Cl. G06T 19/00; G06T 7/70

(52) U.S. Cl. CPC G06T 19/006; G06T 7/70; H04L 65/403

(57) ABSTRACT

An augmented reality (AR) system and an operation method thereof are provided. The AR system includes a target device and an AR device. The target device senses an attitude of the target device to generate attitude information, and provides a digital content and the attitude information to the AR device. The AR device captures the target device to generate an image. The AR device tracks a target location of the target device in the image to perform an AR application. When performing the AR application, the AR device overlays the digital content on the target location in the image, and correspondingly adjusts an attitude of the digital content in the image based on the attitude information of the target device.

### CROSS-REFERENCE TO RELATED APPLICATION

This application claims the priority benefit of Taiwanese application no. 110123328, filed on Jun. 25, 2021. The entirety of the above-mentioned patent application is hereby incorporated by reference herein and made a part of this specification.

### BACKGROUND

### Technical Field

The disclosure relates to a video system. Particularly, the disclosure relates to an augmented reality (AR) system and an operation method thereof.

### Description of Related Art

Various audio-visual streaming services are becoming more and more popular. Common audio-visual streaming services include video conferencing. In a video conference, a user A may show something to a remote user B through a communication network. For example, a mobile phone held by the user A is displaying an interesting digital content (an image or a three-dimensional digital object), and the user A may intend to show the digital content to the remote user B through the video conference. Therefore, the user A sets a video conferencing device to capture an image of the mobile phone. Subject to various environmental factors (e.g., resolution, color shift, etc.), the user B may not be able to clearly see the content displayed by the mobile phone of the user A.

### SUMMARY

The disclosure provides an augmented reality (AR) system and an operation method thereof for performing an augmented reality application.

In an embodiment of the disclosure, the augmented reality system includes a target device and an augmented reality device. The target device is configured to sense an attitude of the target device to generate attitude information. The target device provides a digital content and the attitude information to the augmented reality device. The augmented reality device is configured to capture the target device to generate an image. The augmented reality device tracks a target location of the target device in the image to perform an augmented reality application. In the augmented reality application, the augmented reality device overlays the digital content on the target location in the image. The AR device correspondingly adjusts an attitude of the digital content in the image based on the attitude information of the target device.

In an embodiment of the disclosure, the operation method includes the following. An attitude of a target device is sensed by the target device to generate attitude information. A digital content and the attitude information is provided by the target device to an augmented reality device. The target device is captured by the augmented reality device to generate an image. A target location of the target device in the image is tracked by the augmented reality device to perform an augmented reality application. The digital content is overlaid on the target location in the image by the augmented reality device in the augmented reality application. An attitude of the digital content in the image is correspondingly adjusted by the augmented reality device based on the attitude information of the target device.

Based on the foregoing, in the embodiments of the disclosure, the augmented reality device may capture the target device to generate an image to perform an augmented reality application. The target device may sense the attitude of the target device, and provide the attitude information and the digital content to the augmented reality device. During the process of performing the augmented reality application, the augmented reality device may overlay the digital content provided by the target device on the target location of the target device in the image, and correspondingly adjust the attitude of the digital content in the image based on the attitude information of the target device. Since the digital content is not fixedly stored in the augmented reality device, the augmented reality device may present augmented reality effects more flexibly.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic circuit block diagram of an augmented reality (AR) system according to an embodiment of the disclosure.

FIG. 2 is a schematic flowchart of an operation method of an AR system according to an embodiment of the disclosure.

FIG. 3 is a schematic diagram of an AR application scenario according to an embodiment of the disclosure.

FIG. 4 is a schematic circuit block diagram of a target device according to an embodiment of the disclosure.

FIG. 5 is a schematic circuit block diagram of an AR device according to an embodiment of the disclosure.

### DESCRIPTION OF THE EMBODIMENTS

The term “couple (or connect)” used throughout the whole description of the disclosure (including the claims) may refer to any direct or indirect connection means. For example, if the disclosure describes that a first device is coupled (or connected) to a second device, it should be interpreted that the first device may be directly connected to the second device, or that the first device may be indirectly connected to the second device through other devices or certain connection means. Terms such as “first” and “second” mentioned throughout the whole description of the disclosure (including the claims) are used for naming elements or differentiating between different embodiments or ranges, instead of limiting an upper bound or lower bound of the number of elements or the sequence of elements. Moreover, wherever possible, elements/members/steps using the same reference numerals in the drawings and the embodiments represent the same or similar parts. Cross-reference may be made to related descriptions of elements/members/steps using the same reference numerals or using the same terms in different embodiments.

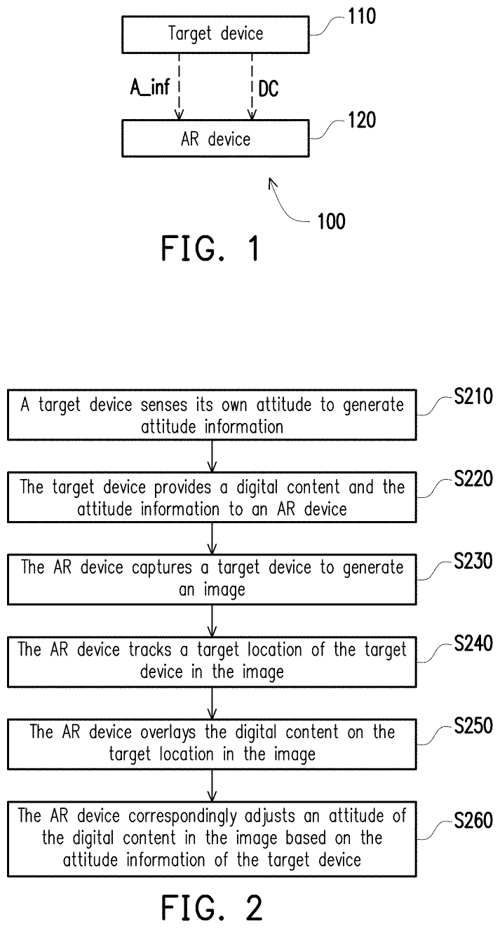

FIG. 1 is a schematic circuit block diagram of an augmented reality (AR) system 100 according to an embodiment of the disclosure. The AR system 100 shown in FIG. 1 includes a target device 110 and an AR device 120. A user may set the AR device 120 to capture the target device 110 to generate an image. In this embodiment, the specific product types of the AR device 120 and the target device 110 are not limited. For example, in some embodiments, the target device 110 may include a mobile phone, a smart watch, a tablet computer, or other electronic devices, and the AR device 120 may include a local computer, a head-mounted display, and/or other AR devices.

FIG. 2 is a schematic flowchart of an operation method of an AR system according to an embodiment of the disclosure. With reference to FIG. 1 and FIG. 2, in step S210, the target device 110 may sense an attitude of the target device 110 itself and generate attitude information A_inf. The AR device 120 may establish a communication connection with the target device 110, such that the target device 110 may provide a digital content DC and the attitude information A_inf to the AR device 120 (step S220). Depending on the actual design, the communication connection may include Bluetooth, a Wi-Fi wireless network, Universal Serial Bus (USB), and/or other communication connection interfaces. The digital content DC may be determined depending on the actual application. For example, in some embodiments, the digital content DC may include a two-dimensional image frame, a three-dimensional digital object, and/or other digital contents. The two-dimensional image frame may include a photo, a video, or other image signals.

In step S230, the AR device 120 may capture the target device 110 to generate an image (or an image stream). In step S240, the AR device 120 may track a target location of the target device 110 in the image to perform an AR application. Depending on the actual design, the AR application may include a game application, an educational application, a video conferencing application, and/or other applications. During the process of performing the AR application, the AR device 120 may overlay the digital content DC provided by the target device 110 on the target location in the image (step S250). Therefore, in some application scenarios, the digital content DC may replace the target device 110 in the image. In step S260, the AR device 120 may correspondingly adjust an attitude of the digital content DC in the image based on the attitude information A_inf of the target device 110. For example, the digital content DC may include a three-dimensional digital object (e.g., a car, an animal, or other three-dimensional objects), and the AR device 120 may correspondingly adjust an attitude of the three-dimensional digital object in the image based on the attitude information A_inf.

As the target device 110 moves, the location of the digital content DC in the image changes accordingly. The user may rotate the target device 110. As the attitude of the target device 110 changes, the attitude of the digital content DC in the image changes accordingly. Depending on the actual application scenario, the target location in the image may be the location of the target device 110, or the target location in the image may be different from the location of the target device 110. For example, when the target device 110 is in the image, the target location may be the location of the target device 110 in the image. When the target device 110 is removed from the image, the AR device 120 takes an effective location of the target device 110 before the target device 110 is removed from the image as the target location. Depending on the actual design, under the premise that the digital content DC may be fully presented, the effective location may be the final location of the target device 110 before being removed from the image.

In some other embodiments, the target device 110 may display a marker MRK (not shown in FIG. 1). Based on the actual design, the marker MRK may include an ArUco marker, a quick response (QR) code, or any predefined geometric figure. The AR device 120 may capture the marker MRK to position the target location in the image. For example, the target location may be the location of the marker MRK in the image. When the marker MRK disappears from the image, the AR device 120 takes the effective location of the marker MRK before the marker MRK disappears from the image as the target location. Depending on the actual design, under the premise that the digital content DC may be fully presented, the effective location may be the final location of the marker MRK before disappearing from the image. Depending on the actual application scenario, the user may operate the target device 110 to not display the marker MRK, such that the marker MRK disappears from the image. In some other application scenarios, the user may turn the direction of the target device 110, such that the AR device 120 cannot capture the marker MRK displayed by the target device 110, thereby causing the marker MRK to disappear from the image. In still some other application scenarios, the user may remove the target device 110 from the image, such that the AR device 120 cannot capture the marker MRK displayed by the target device 110, thereby causing the marker MRK to disappear from the image.

In still some other embodiments, the target device 110 and/or the AR device 120 may have a human-machine interface for the user to operate. When the user triggers the human-machine interface, the AR device 120 takes a current location of the target device 110 constantly as the target location. That is, after the human-machine interface is triggered, the movement of the target device 110 does not affect the target location (the location of the digital content DC).

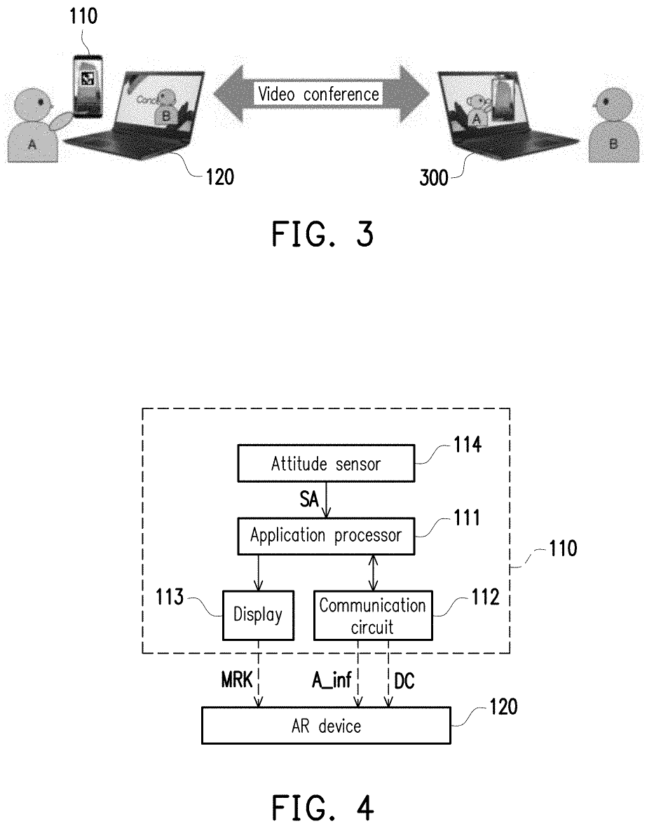

FIG. 3 is a schematic diagram of an AR application scenario according to an embodiment of the disclosure. In the embodiment shown in FIG. 3, the AR application may include a video conferencing application. With reference to FIG. 1 and FIG. 3, the AR device 120 may be connected to a remote device 300 through a communication network. Depending on the actual design, the communication network may include a Wi-Fi wireless network, Ethernet, Internet, and/or other communication networks. In the embodiment shown in FIG. 3, the target device 110 may include a smart phone, and the AR device 120 and the remote device 300 may include a notebook computer. The AR device 120 may transmit an image to the remote device 300 through the communication network to perform the video conference.

In the video conference shown in FIG. 3, the user A may show something to the remote user B through the communication network. For example, the target device 110 held by the user A is displaying an interesting digital content (a two-dimensional image or a three-dimensional digital object), and the user A may intend to show the digital content to the remote user B through the video conference. Therefore, the user A sets the AR device 120 to capture the image displayed by the target device 110. Subject to various environmental factors (e.g., resolution, color shift, etc.), the user B may not be able to clearly see the content displayed by the target device 110 captured by the AR device 120.

Therefore, in the video conference (AR application), the target device 110 may provide the digital content DC and the attitude information A_inf that are being displayed to the AR device 120. The AR device 120 may capture the target device 110 and the user A to generate an image (herein referred to as a conference image). The AR device 120 may overlay the digital content DC on the target device 110 in the conference image to generate an AR conference image. In addition, the AR device 120 may correspondingly adjust the attitude of the digital content DC in the AR conference image (e.g., rotate the direction of the digital content DC) based on the attitude information A_inf of the target device 110. The AR device 120 may transmit the AR conference image to the remote device 300 through the communication network to perform the video conference. The remote device 300 may display the AR conference image to the user B. The digital content that is being displayed by the target device 110 to the user B is not the captured result of the AR device 120. Accordingly, the digital content does not have problems such as resolution, color shift, etc. In addition, the user A may rotate the direction of the target device 110 to present the user B with the digital content DC in different view angles.

For example, based on the actual design, the digital content provided by the target device 110 to the AR device 120 may include a three-dimensional digital object, and the target device 110 has at least one attitude sensor (not shown in FIG. 1 or FIG. 3) to detect the attitude of the target device 110. For example, the attitude sensor may include an acceleration sensor, a gravity sensor, a gyroscope, an electronic compass, and/or other sensors. The target device 110 may provide the AR device 120 with the attitude information A_inf corresponding to the attitude of the target device 110. The AR device 120 may capture the target device 110 to generate the image (e.g., the conference image), and may overlay the three-dimensional object (the digital content DC) on the target device 110 in the image. The AR device 120 may correspondingly adjust the attitude of the three-dimensional digital object in the image based on the attitude information A_inf of the target device 110.

FIG. 4 is a schematic circuit block diagram of a target device 110 according to an embodiment of the disclosure. In the embodiment shown in FIG. 4, the target device 110 includes an application processor 111, a communication circuit 112, a display 113, and an attitude sensor 114. The attitude sensor 114 may detect the attitude of the target device 110 to generate an attitude sensing result SA. The application processor 111 is coupled to the communication circuit 112, the display 113, and the attitude sensor 114. The application processor 111 may generate the attitude information A_inf corresponding to the attitude of the target device 110 based on the attitude sensing result SA. The communication circuit 112 may establish a connection with the AR device 120, so the application processor 111 may provide the digital content DC and the attitude information A_inf to the AR device 120 through the communication circuit 112. Based on the drive and control of the application processor 111, the display 113 may display the marker MRK. Based on the actual design, the marker MRK may include an ArUco marker, a QR code, or any predefined geometric figure. The AR device 120 may capture the marker MRK displayed by the display 113 to position the target location of the target device 110 in the image.

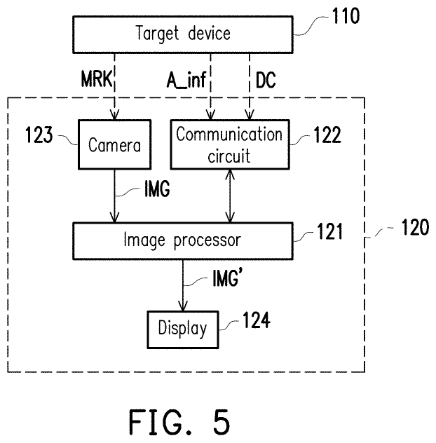

FIG. 5 is a schematic circuit block diagram of an AR device 120 according to an embodiment of the disclosure. In the embodiment shown in FIG. 5, the AR device 120 includes an image processor 121, a communication circuit 122, a camera 123, and a display 124. The image processor 121 is coupled to the communication circuit 122, the camera 123, and the display 124. The communication circuit 122 may establish a connection with the target device 110 to receive the digital content DC and the attitude information A_inf. The camera 123 may capture the target device 110 to generate an image IMG. The image processor 121 may position the target location of the target device 110 in the image IMG. The image processor 121 may overlay the digital content DC on the target location in the image IMG to generate an overlaid image IMG′. The image processor 121 may also correspondingly adjust the attitude of the digital content DC in the image IMG′ (e.g., rotate the direction of the digital content DC) based on the attitude information A_inf of the target device 110. The display 124 is coupled to the image processor 121 to receive the image IMG′. Based on the driving and control of the image processor 121, the display 124 may display the image IMG′ after being overlaid with the digital content DC.

Depending on different design requirements, the application processor 111 and/or the image processor 121 may be realized by hardware, firmware, software (i.e., programs), or a combination of more than one of the above three forms. In terms of the hardware form, the application processor 111 and/or the image processor 121 may be implemented in a logic circuit on an integrated circuit. The relevant functions of the application processor 111 and/or the image processor 121 may be implemented as hardware by utilizing hardware description languages (e.g., Verilog HDL or VHDL) or other suitable programming languages. For example, the relevant functions of the application processor 111 and/or the image processor 121 may be implemented in various logic blocks, modules, and circuits in one or more controllers, microcontrollers, microprocessors, application-specific integrated circuits (ASIC), digital signal processors (DSP), field programmable gate arrays (FPGA), and/or other processing units.

In terms of the software form and/or firmware form, the relevant functions of the application processor 111 and/or the image processor 121 may be implemented as programming codes. For example, the application processor 111 and/or the image processor 121 may be implement by utilizing general programming languages (e.g., C, C++, or assembly language) or other suitable programming languages. The programming codes may be recorded/stored in a “non-transitory computer readable medium”. In some embodiments, the non-transitory computer readable medium includes, for example, read only memory (ROM), a tape, a disk, a card, semiconductor memory, a programmable logic circuit, and/or a storage device. The storage device includes a hard disk drive (HDD), a solid-state drive (SSD), or other storage devices. A computer, a central processing unit (CPU), a controller, a microcontroller, or a microprocessor may read and execute the programming codes from the non-transitory computer readable medium, thereby realizing the relevant functions of the application processor 111 and/or the image processor 121. Moreover, the programming codes may also be provided to the computer (or CPU) through any transmission medium (a communication network, a radio wave, or the like). The communication network is, for example, the Internet, a wired communication network, a wireless communication network, or other communication media.

In summary of the foregoing, in the foregoing embodiments, the AR device 120 may 5/4 capture the target device 110 to generate an image to perform an AR application. The target device 110 may sense the attitude of itself, and provide the attitude information A_inf and the digital content DC to the AR device 120. During the process of performing the AR application, the AR device 120 may overlay the digital content DC provided by the target device 110 on the target location of the target device 110 in the image IMG, and correspondingly adjust the attitude of the digital content DC in the image IMG′ (e.g., rotate the direction of the digital content DC) based on the attitude information A_inf of the target device 110. Since the digital content DC is not fixedly stored in the AR device 120, the AR device 120 may present AR effects more flexibly.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An augmented reality system, comprising:
a target device, configured to sense an attitude of the target device to generate attitude information; and
an augmented reality device, configured to capture the target device to generate an image, wherein the target device provides a digital content and the attitude information to the augmented reality device, the augmented reality device tracks a target location of the target device in the image to perform an augmented reality application, the augmented reality device overlays the digital content on the target location in the image in the augmented reality application, and the augmented reality device correspondingly adjusts an attitude of the digital content in the image based on the attitude information of the target device.

2. The augmented reality system as described in claim 1, wherein in the augmented reality application, the augmented reality device transmits the image to a remote device through a communication network to perform a video conference.

3. The augmented reality system as described in claim 1, wherein the digital content comprises a three-dimensional digital object, and the augmented reality device correspondingly adjusts an attitude of the three-dimensional digital object in the image based on the attitude information.

4. The augmented reality system as described in claim 1, wherein in response to the target device being removed from the image, the augmented reality device takes an effective location of the target device before the target device is removed from the image as the target location.

5. The augmented reality system as described in claim 1, wherein the target device displays a marker, and the augmented reality device captures the marker to position the target location in the image, and
in response to the marker disappearing from the image, the augmented reality device takes an effective location of the marker before the marker disappears from the image as the target location.

6. The augmented reality system as described in claim 1, wherein the target device or the augmented reality device has a human-machine interface, and
in response to the human-machine interface being triggered, the augmented reality device takes a current location of the target device constantly as the target location.

7. The augmented reality system as described in claim 1, wherein the target device comprises:
an attitude sensor, configured to detect the attitude of the target device to generate an attitude sensing result;
a communication circuit, configured to establish a connection with the augmented reality device; and
an application processor, coupled to the attitude sensor and the communication circuit, wherein the application processor generates the attitude information based on the attitude sensing result, and the application processor provides the digital content and the attitude information to the augmented reality device through the communication circuit.

8. The augmented reality system as described in claim 7, where the target device further comprises:
a display, coupled to the application processor and configured to display a marker, wherein the augmented reality device captures the marker to position the target location of the target device in the image.

9. The augmented reality system as described in claim 8, wherein the marker comprises an ArUco marker.

10. The augmented reality system as described in claim 1, wherein the augmented reality device comprises:
a communication circuit, configured to establish a connection with the target device to receive the digital content and the attitude information;
a camera, configured to capture the target device to generate the image; and
an image processor, coupled to the communication circuit and the camera, wherein the image processor positions the target location of the target device in the image, the image processor overlays the digital content on the target location in the image, and the image processor correspondingly adjusts the attitude of the digital content in the image based on the attitude information.

11. The augmented reality system as described in claim 10, wherein the augmented reality device further comprises:
a display, coupled to the image processor and configured to display the image after being overlaid with the digital content.

12. The augmented reality system as described in claim 1, wherein the target device comprises a mobile phone, and the augmented reality device comprises a local computer.

13. An operation method of augmented reality system, comprising:
sensing an attitude of a target device by the target device to generate attitude information;
providing a digital content and the attitude information by the target device to an augmented reality device;
capturing the target device by the augmented reality device to generate an image;
tracking a target location of the target device in the image by the augmented reality device to perform an augmented reality application;
overlaying the digital content on the target location in the image by the augmented reality device in the augmented reality application; and
correspondingly adjusting the attitude of the digital content in the image by the augmented reality device based on the attitude information of the target device.

14. The operation method as described in claim 13, further comprising:
in the augmented reality application, transmitting the image by the augmented reality device to a remote device through a communication network to perform a video conference.

15. The operation method as described in claim 13, wherein the digital content comprises a three-dimensional digital object, and the augmented reality device correspondingly adjusts an attitude of the three-dimensional digital object in the image based on the attitude information.

16. The operation method as described in claim 13, further comprising:
in response to the target device being removed from the image, by the augmented reality device, taking an effective location of the target device before the target device is removed from the image as the target location.

17. The operation method as described in claim 13, further comprising:
displaying a marker by the target device;
capturing the marker by the augmented reality device to position the target location in the image; and
in response to the marker disappearing from the image, by the augmented reality device, taking an effective location of the marker before the marker disappears from the image as the target location.

18. The operation method as described in claim 17, wherein the marker comprises an ArUco marker.

19. The operation method as described in claim 13, wherein the target device or the augmented reality device has a human-machine interface, and the operation method further comprises:
in response to the human-machine interface being triggered, by the augmented reality device, taking a current location of the target device constantly as the target location.

20. The operation method as described in claim 13, wherein the target device comprises a mobile phone, and the augmented reality device comprises a local computer.
